(19) United States
(12) Patent Application Publication
(10) Pub. No.: US 2022/0174996 A1
(43) Pub. Date: Jun. 9, 2022

(54) EDIBLE PRODUCT COMPRISING PLANT OILS OR CREAMS AND COOKED LEGUMES

(71) Applicant: ForA Foods Co., New York, NY (US)

(72) Inventors: Aidan Altman, New York, NY (US); Andrew McClure, New York, NY (US)

(21) Appl. No.: 16/975,290

(22) PCT Filed: Jan. 31, 2019
(86) PCT No.: PCT/US2019/016082

§ 371 Date: Aug. 24, 2020

Related U.S. Application Data
(60) Provisional application No. 62/634,372, filed on Feb. 23, 2018.

(51) Int. Cl. A23L 11/00; A23L 35/00; A23L 27/60; A23L 9/20; A23D 7/005

(52) U.S. Cl. CPC A23L 11/05; A23L 35/20; A23D 7/0056; A23L 9/20; A23L 27/66

(57) ABSTRACT

The teachings envision a formulation including two or more edible plant oils or creams; and a product resulting from cooking one or more types of legumes. The formulation may be a condiment spread, topping, or cooking or baking ingredient, such as a butter. The formulation may further include an edible oil, cream, or milk derived from a plant and having a lower fatty acid content than another edible plant oil or cream within the formulation. The formulation may include one or more emulsifying agents, one or more flavoring agents, one or more additives, or a combination thereof. The present teachings also include a process for making the formulation.

### FIELD

The teachings relate to a formulation of and method of making an edible product, and more particularly to a formulation of and method of making a creamy, spreadable condiment, topping, or product for use in cooking or baking.

### BACKGROUND

Consumers are becoming more conscious about the foods they eat, as well as the sources of and ingredients in these foods. The market for healthier condiments and ingredients is growing. With consumers increasingly interested in healthy fats like avocado and coconuts, this has also driven the production of specialty oils, such as sesame oil, flax oil, nut oils, hemp oil, and grapeseed oil. There is also a push for sustainable production methods, as many methods require a great deal of land, water, and food to create the products.

Consumers following a vegan lifestyle do not eat or use animal products. In addition, those with certain dietary restrictions or allergies, particularly to dairy products, have to avoid certain foods. Other consumers prefer clean products, avoiding overly processed products or those with additives. However, these consumers still seek substitute products that mimic the taste and/or texture of some animal-derived counterparts.

Often, these similar products do not share the same properties or qualities as the products they seek to replace. For example, certain alternative butters do not have the same consistencies or cookability as traditional butter. Alternative butters may lack the creamy mouthfeel of traditional butter. Alternative butters may not be able to cook, bake, spread, and/or melt like traditional butter.

Therefore, there remains a need for alternative food products, such as condiments, toppings, and/or spreads, having qualities that mimic the taste and/or texture of the products being replaced. There is also a need for alternative food products that mimic the qualities of other products, such as being cookable, meltable, bakeable, spreadable, and the like. There is also a need for condiments, spreads, or ingredients that are an appealing choice for the health-focused market.

### SUMMARY

The present teachings overcome one or more of the above needs by providing a formulation, such as a condiment spread, topping, baking ingredient, cooking ingredient, or a combination thereof, that includes two or more edible plant oils or creams and a product resulting from cooking one or more types of legumes. The formulation may further include an edible oil, cream, or milk derived from a plant. The edible oil, cream or milk may have a lower fatty acid content than another edible plant oil or cream within the formulation. The two or more edible plant oils or creams may be selected from any combination of cottonseed oil (e.g., hydrogenated), palm oil (e.g., hydrogenated), coconut oil, palm kernel oil, pilu oil, bay leaf oil, almond yogurt, coconut yogurt, cashew yogurt, and coconut cream.

The formulation may include an oil or cream derived from a plant having a saturated fatty acid content in excess of 70% by weight of total fat. The oil or cream may be present in an amount of about 50% or greater by volume of the formulation. The formulation may include a slurry or emulsion having a relatively high viscosity. The viscosity of the slurry or emulsion may be about 1000 centipoise (cP) or greater. The viscosity of the slurry or emulsion may be about 250,000 cP or less. The slurry or emulsion may be a cream or yogurt. The slurry or emulsion may be present in an amount of about 20% or greater by volume of the formulation. The slurry or emulsion may be selected from one or more of almond yogurt, coconut yogurt, cashew yogurt, and coconut cream. The formulation may include another oil, cream, or milk from a plant having a saturated fatty acid content less than 70% by weight of the total fat. The oil, cream, or milk may be selected from one or more of oils derived from seeds or nuts (which may be detoxified), safflower oil, grapeseed oil, rapeseed oil, hemp seed oil, flaxseed oil, linseed oil, canola oil, sunflower oil, avocado oil, corn oil, olive oil, peanut oil, soybean oil, palm oil, cottonseed oil, tigernut oil, almond milk, cashew milk, and coconut milk. The formulation may include a product resulting from cooking one or more types of legumes.

The legumes of the formulation may be characterized as having a carbohydrate to protein content in a ratio of about 2:1 to about 4:1, a carbohydrate to lipid content in a ratio of about 9:1 to about 12:1, a protein to lipid content in a ratio of about 2:1 to about 5:1, or a combination thereof. The legumes may be selected from any combination of black beans, pinto beans, green split peas, adzuki beans, mung beans, chickpeas, green peas, roman beans, light red beans, pink peas, kidney beans, lima beans, lentils, and navy beans. The product resulting from cooking one or more types of legumes may act as an emulsifying agent within the formulation. The product resulting from cooking one or more types of legumes may be in a viscous liquid form. This may be present in an amount of about 20% or less by volume of the formulation. The product resulting from cooking one or more types of legumes may be in a dried or dehydrated form. This may be present in an about of about 10% or less by volume of the formulation, or about 1% or less by volume of the formulation.

The formulation may include one or more emulsifiers (e.g., in addition to the product resulting from cooking one or more legumes). The emulsifier may include lecithin from a plant source. The lecithin may be present in an amount of about 0.2% or greater by volume of the formulation and about 3% or less by volume of the formulation. The formulation may include one or more additives. The additives may be selected from salt, citrus juice, lactic acid, cultured dextrose, vinegar, sodium benzoate, potassium sorbate, or a combination thereof. The formulation may include one or more natural flavorings. The natural flavoring may include a yeast product, such as a deactivated yeast. The yeast may include a strain of microorganism Saccharomyces cerevisiae. The yeast product may be present in an amount of about 0.5% or greater by volume of the formulation and about 3% or less by volume.

The teachings herein further include a process for making the formulation as described herein. The process may include blending or mixing the ingredients. The process may further include a step of pasteurizing the ingredients and/or the formulation.

The formulation as described herein may form a condiment spread that is a butter (or butter substitute). The butter may be spreadable, meltable, cookable, creamy, or a combination thereof. It is also contemplated that the formulation may be a spread, topping, or dessert product, such as a whipped topping, frosting, salad dressing, mayonnaise, pudding, dipping sauce, legume-based spread, or the like. The formulation may also be used as an egg substitute or cheese substitute.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

In general, the teachings herein contemplate an edible product, in particular a condiment, such as one that is spreadable. For purposes of the present teachings, the term “condiment” includes spreads, toppings, sauces, meltable substance used for cooking (e.g., for melting in a pan to prevent other foods from sticking, to aid in cooking, to add flavor, or a combination thereof), or ingredients used to make other edible products (e.g., an ingredient within a baked good or other food item). The condiment may be a butter alternative that has a creamy and/or dairy-like mouthfeel. The condiment may taste, cook, bake, spread and/or melt like traditional butter. The condiment may be left out at room temperature for a period of time without melting completely and/or separating (e.g., within about 1 hour or more and/or about 2 hours or less). When left out at room temperature, the condiment may soften but may still remain spreadable and not separated, similar to traditional dairy butter. The condiment may be left out at room temperature for a period of time and still be usable and edible. For example, the condiment may be left out at room temperature for about 24 hours or more, about 48 hours or less, or both, to mimic the timeframe traditional butter may be left out. The scope of the teachings also encompasses other spreads, toppings, or dessert products, such as whipped toppings (e.g., those that are non-dairy based), frostings, dessert puddings, salad dressings, mayonnaise (e.g., vegan mayonnaise), dipping sauces, legume-based spreads, or the like. The present teachings also include butter substitutes, egg substitutes, and cheese substitutes, which may include cottage cheese (e.g., non-dairy cottage cheese) and sour cream (e.g., non-dairy sour cream). The teachings herein are not to be limited to a butter or butter substitute, and where “edible product,” “condiment,” or “spreadable condiment” is used herein, it is intended to encompass any or all of these products.

The teachings herein contemplate an edible product that includes one or more edible plant oils or creams, and one or more products resulting from cooking one or more types of legumes. The edible product may include additional edible oils, creams, or milks, which are derived from a plant, and may have a lower fatty acid content than other edible plant oils or creams in the product. The edible product may include one or more emulsifiers. The edible product may include one or more edible yeasts (e.g., nutritional yeast or deactivated yeast). The edible product may include one or more other ingredients or additives. The edible product may be a butter-type product, or an alternative to traditional butter.

The edible product may include one or more plant oils or creams. The oil or cream may be derived from one or more plant sources. One or more plant oils or creams may serve as the base ingredient for the edible product. The one or more plant oils or creams may be present in the greatest amount as compared with other ingredients to form the edible product (e.g., in parts by volume). The oil, cream, or both, due to the fat content and/or the viscosity may impact the creaminess and/or thickness of the edible product.

A plant oil (or cream) may have a high fatty acid content. The fatty acid may include one or more C8-C18 fatty acids. For example, the fatty acid may include lauric acid, caprylic acid, decanoic acid, myristic acid, palmitic acid, oleic acid, stearic acid, the like, or a combination thereof. The fatty acid may have a high lauric acid content (e.g., about 25% or greater by weight of total fat, about 35% or greater, or about 45% or greater). The plant oil (or cream) may have a high saturated fat content. The fatty acid content may be a majority saturated fatty acid. The saturated fatty acid content may be less than 100% by weight of total fat, about 95% or less by weight of total fat, or about 90% or less by weight of total fat. The saturated fatty acid content may be about 45% or greater by weight of total fat, about 70% or greater by weight of total fat, or about 80% or greater by weight of total fat. The fatty acid content may affect the saponification value of the plant oil (or cream). The plant oil may have a saponification value of about 175 or greater, about 190 or greater, about 200 or greater, about 220 or greater, or about 240 or greater.

Oils may be supplied as virgin oils, extra virgin oils, refined oils, unrefined oils, hydrogenated oils, fractionated oil, or a combination thereof. Exemplary plant oils may include, but are not limited to, cottonseed oil (e.g., hydrogenated), palm oil (e.g., hydrogenated), coconut oil, palm kernel oil, pilu oil, and bay leaf oil.

A cream within the edible product may be formed from a slurry or emulsion having a relatively high viscosity. The cream may function to provide a thicker and/or smoother consistency to the edible product. Such creams may have a viscosity at room temperature of about 1000 centipoise (cP) or greater, about 2000 cP or greater, about 3000 cP or greater, about 5000 cP or greater, or about 10,000 cP or greater. The creams may have a viscosity at room temperature of about 250,000 cP or less, about 200,000 cP or less, about 100,000 cP or less, or about 50,000 cP or less.

Exemplary creams may include, but are not limited to, almond yogurt, coconut yogurt, cashew yogurt, coconut cream, and the like. It is contemplated that the edible product may include two or more plant oils or creams. For example, the edible product may include an oil and a cream. The edible product may include two creams (e.g., a yogurt and another cream).

The edible product, such as a condiment, may include one or more additional oils, creams, or milks derived from a plant source. The plant oil, cream, or milk may have a lower fatty acid content as compared with other oils or creams in the product, such as the oils or creams discussed above. Such plant oil, cream, or milk may function to allow the formulation to be more easily blended and/or may, at least in part, provide a smoother consistency (e.g., one that is not flaky or grainy). The one or more oils, creams, or milks may have a saturated fatty acid content that is about 55% or less by weight of total fat, about 50% or less by weight of total fat, or about 30% or less by weight of total fat. The one or more oils, creams, or milks may have a saturated fatty acid content that is greater than 0% by weight of total fat, about 5% or greater by weight of total fat, or about 7% or greater by weight of total fat.

The one or more oils, creams, or milks derived from a plant source may be generally neutral or may be acidic (e.g., mildly acidic). For example, sunflower oil and safflower oil may be mildly acidic. One or more oils, creams, or milks may have a pH of about 7 or less. One or more oils, creams, or milks may have a pH of about 4 or greater. One or more oils, creams, or milks may be alkaline (e.g., mildly alkaline). For example, flaxseed oil and hemp oil may be neutral or mildly alkaline. One or more oils, creams, or milks may have a pH of about 7 or greater. One or more oils, creams, or milks, may have a pH of about 10 or less.

The one or more oils, creams, or milks derived from a plant source may have a higher smoke point as compared with other oils or creams in the product. The one or more oils, creams, or milks may have a smoke point that is about 180° C. or greater, about 190° C. or greater, or about 200° C. or greater. The one or more oils, creams, or milks may have a smoke point that is about 300° C. or less, about 275° C. or less, or about 250° C. or less.

Exemplary oils, creams, or milks may include, but are not limited to, oils derived from seeds or nuts (which may be detoxified), safflower oil, grapeseed oil, rapeseed oil, hemp seed oil, flaxseed oil, linseed oil, canola oil, sunflower oil, avocado oil, corn oil, olive oil, peanut oil, soybean oil, palm oil, cottonseed oil, tigernut oil, almond milk, cashew milk, and coconut milk.

The edible product may include one or more emulsifiers to encourage the suspension of one liquid in another within the formulation. One emulsifier to bind the oils and water of the formulation may be a product resulting from cooking one or more types of legumes. The product may be the broth of cooked legumes. To obtain a product resulting from cooking one or more types of legumes, the legumes may be hydrated and/or soaked and then heated until the legumes are tender. A strainer or sieve may be used to strain the legumes, separating the legumes from the liquid. The resulting liquid may then be used or dried to be used within the formulation. The product resulting from cooking one or more types of legumes may be aquafaba. The product can be left in a viscous liquid state, or it may be dehydrated or dried (e.g., to form a solid or powder). Such products, like aquafaba, may be used to replace egg whites, as they contain a mix of starches, proteins, and other soluble plant solids, which have migrated from the seeds to the water during the cooking process. The product resulting from cooking one or more legumes has also given the edible product an unexpected depth of flavor and/or its creamy, dairy-like mouthfeel.

The legumes that are cooked may include carbohydrates, proteins, and lipids. The legume may have a carbohydrate to protein ratio of about 1:1 or greater or about 2:1 or greater. The legume may have a carbohydrate to protein ratio of about 5:1 or less, or about 4:1 or less. For example, the legume may have a carbohydrate to protein content of about 2:1 to about 4:1. The legume may have a carbohydrate to lipid ratio of about 8:1 or greater or about 9:1 or greater. The legume may have a carbohydrate to lipid ratio of about 13:1 or less or about 12:1 or less. For example, the legume cooked may have a carbohydrate to lipid ratio of about 9:1 to about 12:1. The legume may have a protein to lipid ratio of about 1:1 or greater or about 2:1 or greater. The legume may have a protein to lipid ratio of about 6:1 or less or about 5:1 or less. For example, the legume may have a protein to lipid ratio of about 2:1 to about 5:1.

Non-limiting examples of legumes that can be sources of aquafaba, or that can be cooked to produce the desired emulsifying ingredient, include black beans, pinto beans, green split peas, adzuki beans, mung beans, chickpeas, green peas, roman beans, light red beans, pink peas, kidney beans, lima beans, lentils, and navy beans.

The formulation of the edible product may include one or more additional ingredients that may act as emulsifiers. The formulation may include one or more amphiphilic ingredients, attracting both water and fatty substances, which may be used to smooth the texture of the formulation, dissolve powders, and/or homogenize liquid mixtures. For example, the formulation may include one or more mixtures of glycerophospholipids, including phosphatidylcholine, phosphatidylethanolamine, phosphatidylinositol, and phosphatidic acid. These mixtures may be one or more lecithins, such as a lecithin derived from a plant source. Lecithins may be extracted from plant sources such as soybeans, rapeseed, cottonseed, and sunflower. Lecithins may also be extracted from marine sources, eggs, and/or milk. The lecithins may be supplied in a solid (e.g., powdered) or a liquid form.

Other emulsifiers and/or stabilizers may be added to the formulation, including mustard, honey, milk, milk proteins, butter, egg whites, egg white powder, sodium citrate, nut oils, rendered fat (e.g., from bacon or other meat products), olive fat, salt (e.g., table salt or sea salt), the like, or a combination thereof.

The formulation of the edible product may include one or more additional ingredients. These ingredients may impact the flavor of the edible product, the texture of the edible product, the stability of the edible product, the like, or a combination thereof. The formulation may include water or other liquids, which may assist in mixing the ingredients of the formulation. The water may be cooked off or may remain in the formulation during processing. The formulation may include one or more edible yeasts. The edible yeast may be a deactivated yeast. The deactivated yeast may include a strain of microorganism Saccharomyces cerevisiae. For example, the formulation may include nutritional yeast, which may provide a savory taste (e.g., nutty and/or cheesy). The nutritional yeast may act to thicken the formulation. The nutritional yeast may enhance the nutrition of the formulation, as nutritional yeast is a source of protein, B-complex vitamins, folates, thiamine, riboflavin, niacin, selenium, and zinc.

The formulation may include one or more nutritional components, such as vitamins and/or minerals. The formulation may be fortified (e.g., with one or more vitamins and/or minerals). The nutritional components may be measurable due to the presence of other components and/or may be added separately. The formulation may include one or more of Vitamin A, Vitamin B (e.g., B1, B3, B6, B12), Vitamin C, Vitamin D, Vitamin E, Vitamin K. For example, the formulation may include one or more D vitamins, such as Vitamin D2 and/or Vitamin D3. The formulation may include pantothenic acid, biotin, folate, folic acid, or a combination thereof. The formulation may include minerals such as calcium, chromium, copper, fluorine, fluoride, iodine, iron, magnesium, manganese, phosphorus, potassium, zinc, or a combination thereof.

The flavor profile may be enhanced by other ingredients. The flavor may be enhanced by one or more spices, where a spice may be or may be derived from a seed, fruit, root, bark, bean, pod, or other plant substance. Exemplary spices include, but are not limited to, basil, rosemary, garlic, ginger, dill, parsley, thyme, mint, oregano, coriander, sage, chives, tarragon, paprika, star anise, turmeric, allspice, nutmeg, cinnamon, cumin, cardamom, cloves, fennel seeds, onion, vanilla, honey, coffee, cocoa, pepper and/or peppers (e.g., black, cayenne, red pepper, peppercorns, jalapeno, serrano, tabasco, thai, habanero, ghost), chiles, chia seeds, poppy seeds, sesame, sunflower seeds, flaxseed, pine nuts, oats, the like, or a combination thereof. Spices may include edible seeds falling under categories of cereals, pseudocereals, legumes, nuts, gymnosperms, or other. Blends of spices are also contemplated. Exemplary blends include curry, pumpkin pie, poultry seasoning, pickling spices, Italian seasoning, Herbes de Provence, Greek seasoning, masala, gingerbread spice, creole seasoning, Cajun seasoning, burger seasoning, brisket rub, barbecue, apple pie spice, the like, or a combination thereof. Spices or blends from India, East Asia, the Middle East, Mexico, South America, North America, and Europe are contemplated. The flavor may be enhanced by one or more herbs, where an herb may be leaves, flowers, or stems of a plant. The formulation may be sweetened or made more sour or tart. Salt, such as table salt or sea salt, may be added to reduce bitterness or improve or increase sweet and/or sour flavors. A more sour or tart flavor may be achieved, for example, through the addition of citrus juice (e.g., lemon juice, lime juice, orange juice, grapefruit juice), vinegar, lactic acid, or a combination thereof. A sweeter flavor may be achieved through adding citric acid or sugar, for example, to the formulation.

One or more ingredients may be added to inhibit the growth of undesirable bacteria and mold in the edible product. Examples of preservatives include, but are not limited to, benzoates (e.g., sodium benzoate), dextrose (e.g., cultured dextrose), or sorbates (e.g., potassium sorbate). Spices may also be used for preserving the formulation.

The edible product may include other additives, including but not limited to, ingredients that provide, modify, or enhance the flavor and/or color; modify the viscosity of the formulation; stabilize the formulation; modify the texture and/or mouthfeel of the formulation, and/or provide or enhance the nutritional benefits of the product. Flavor particulates may be added, such as nuts, fruits, vegetables, or extracts thereof. The edible product may include, for example, and not to serve as limiting, carrot, celery, peppers, cucumber, peas, zucchini, broccoli, cauliflower, squash, fig, cranberry, shallot, asparagus, garlic, radish, onion, brussels sprouts, spinach, artichoke, sweet potato, potato, mushroom, tomato, corn, pomegranate, pineapple, pear, plum, apple, banana, kiwi, avocado, papaya, mango, orange, lemon, lime, watermelon, melon, peach, tangerine, berry, grape, coconut, apricot, the like, or combination thereof. Extracts or food dyes may be used to provide or enhance coloring of the edible product. Natural food dyes such as carotenoids, chlorophyllin, anthocyanins, and/or betanin may be used. Colorants or specialized derivatives, such as annatto extract, caramel coloring made from caramelized sugar, carmine, elderberry juice, lycopene, paprika, turmeric, or spirulina may be used.

The edible product may have any of the following, in any combination, nutritional characteristics per 100 grams.

The edible product may have about 500 calories or more, about 600 calories or more, or about 700 calories or more per 100 gram serving. The edible product may have about 1500 calories or less, about 1000 calories or less, or about 800 calories or less per 100 gram serving.

The edible product may have a total fat content per 100 grams of about 50 grams or more, about 60 grams or more, or about 75 grams or more. The edible product may have a total fat content per 100 grams of about 95 grams or less, about 85 grams or less, or about 80 grams or less. The total fat may be measured according to AOAC 996.06. Measurement of fat by fatty acid profile may be measured according to AOAC 996.06.

The edible product may have one or more of monounsaturated fat, polyunsaturated fat, saturated fat, and trans fat. The edible product may have more saturated fat than any of the other fats, alone or in combination. The saturated fat may account for about 60% or more of the total fat, about 65% or more of the total fat, or about 70% or more of the total fat. The saturated fat may account for about 100% or less of the total fat. The monounsaturated fat may account for about 5% or more of the total fat, about 10% or more of the total fat, or about 15% or more of the total fat. The monounsaturated fat may account for about 35% or less of the total fat, about 30% or less of the total fat, or about 25% or less of the total fat. The polyunsaturated fat may account for about 0% or more of the total fat. The polyunsaturated fat may account for about 10% or less of the total fat, about 5% or less of the total fat, or about 3.5% or less of the total fat. The trans fat may account for about 0% or more of the total fat. The trans fat may account for about 1% or less of the total fat, about 0.5% or less of the total fat, or about 0.1% or less of the total fat.

The edible product may have cholesterol per 100 grams in the amount of about 5 mg or less, about 2 mg or less, or about 1 mg or less. The edible product may have cholesterol per 100 grams in the amount of about 0 mg or more. Cholesterol may be measured according to AOAC 994.10.

The edible product may have a sodium content per 100 grams of about 100 mg or more, about 200 mg or more, or about 300 mg or more. The edible product may have a sodium content per 100 grams of about 600 mg or less, about 500 mg or less, or about 400 mg or less. Sodium may be measured according to AOAC 984.27.

The edible product may have a potassium content per 100 grams of about 25 mg or more, about 40 mg or more, or about 50 mg or more. The edible product may have a potassium content per 100 grams of about 100 mg or less, about 75 mg or less, or about 60 mg or less. Potassium may be measured according to AOAC 984.27.

The edible product may have a total carbohydrate content per 100 grams of about 0.5 grams or more, about 1 gram or more, or about 2 grams or more. The edible product may have a total carbohydrate content of about 10 grams or less, about 5 grams or less, or about 3 grams or less.

The edible product may have a dietary fiber content per 100 grams of about 0.1 grams or more, about 0.25 grams or more, or about 0.4 grams or more. The edible product may have a dietary fiber content of about 5 grams or less, about 3 grams or less, or about 1 gram or less. The dietary fiber measurement may include polysaccharides not currently recognized as dietary fiber by the Federal Drug Administration. The dietary fiber may be measured according to AOAC 991.43.

The edible product may have a total sugar content per 100 grams of about 0 grams or more. The edible product may have a total sugar content of about 5 grams or less, about 1 gram or less, or about 0.5 grams or less. The total sugar may be measured according to AOAC 980.13. The total sugars value may be the sum of all naturally occurring and added sugars. Sugars may include fructose, glucose, lactose, maltose, and sucrose, for example.

The edible product may have a protein content per 100 grams of about 0 grams or more. The edible product may have a protein content of about 5 grams or less, about 2 grams or less, or about 1 gram or less. Protein may be measured according to AOAC 991.20.I. The protein factor, using the Kjeldahl method, may be 6.25.

The edible product may have a calcium content per 100 grams of about 1 mg or more, about 2 mg or more, or about 5 mg or more. The edible product may have a calcium content of about 15 mg or less, about 10 mg or less, or about 8 mg or less. Calcium may be measured according to AOAC 984.27.

The edible product may have an iron content per 100 grams of about 0 mg or greater. The edible product may have an iron content of about 2 mg or less, about 1 mg or less, or about 0.5 mg or less. Iron may be measured according to AOAC 984.27.

The edible product may have a moisture content per 100 grams of about 10 grams or more, about 13 grams or more, or about 15 grams or more. The edible product may have a moisture content of about 30 grams or less, about 25 grams or less, or about 20 grams or less. Moisture content may be measured according to AOAC 926.08.

The edible product may have an ash content per 100 grams of about 0 grams or more. The edible product may have an ash content of about 2 grams or less, about 1.5 grams or less, or about 1 gram or less. Ash may be measured according to AOAC 945.46.

The edible product may have a total Vitamin D content per 100 grams of about 0 micrograms or more. The edible product may have a total Vitamin D content of about 5 micrograms or less, about 3 micrograms or less, or about 2 micrograms or less. The Vitamin D content may include Vitamin D2, Vitamin D3, or both. The amounts of each may be equal. The amounts of one may be greater than the other. For example, the amount of Vitamin D2 may be greater than the amount of Vitamin D3. Total Vitamin D may be measured according to AOAC 2011.11 Mod.

The edible product may meet regulations pertaining to pH and/or water activity (Aw). The edible product may require proper refrigeration. The edible product may have a water activity that provides sufficient moisture to support the growth of bacteria, yeasts, mold, or a combination thereof. The edible product may have a water activity that is about 0.85 or greater, about 0.90 or greater, or about 0.95 or greater (e.g., about 0.960 to about 0.965). Water activity may be measured according to AOAC 978.18. The Aw temperature may be about 24.9° C.

The edible product may have a pH of about 7 or less, about 6.5 or less, or about 6 or less. The edible product may have a generally acidic pH. The pH may be about 4.6 or less, about 4.5 or less, or about 4.4 or less. The pH may be about 3.0 or more, about 3.5 or more, or about 4.0 or more. The pH may be measured according to ISO 7238:2004.

The edible product may have a melting point that allows the product to melt as desired. For example, the edible product may serve as a butter substitute, and it may be desirable to melt under similar conditions as butter (e.g., when spreading on toast, when heating in a pan, or when baking). The edible product may have a melting point of about 15° C. or greater, about 17° C. or greater, or about 20° C. or greater. The edible product may have a melting point of about 35° C. or less, about 32° C. or less, or about 25° C. or less. The melting point may be measured according to AOCS Cc 1-25 (Melting Point Capillary Tube).

The edible product may have a smoke point that allows the product to be used for cooking. The edible product may have a smoke point that is best suited for lower temperature cooking methods. For example, the edible product may have a smoke point that allows for use in sautéing. The edible product may have a smoke point greater than butter. The edible product may have a smoke point of about 150° C. or greater, about 165° C. or greater, or about 180° C. or greater. The edible product may have a smoke point that is about 200° C. or less, about 190° C. or less, or about 185° C. or less. Smoke point may be measured according to AOCS Cc 9a-48.

The edible product may contain each ingredient in amounts that avoid negative results. Negative results may include the emulsion breaking with air-melting or cooking, or clumping during the cooking and/or melting process. Certain combinations or amounts of ingredients may result in a hard, unspreadable product; a flaky product; grainy mouthfeel; a bitter and/or sour flavor; or a combination thereof. The present teachings envision a spreadable condiment with a creamy mouthfeel. The present teachings also result in an edible product, such as a condiment, that is meltable and/or cookable. The resulting edible product may be a spreadable butter alternative with a dairy-like, cheesy, and/or nutty flavor.

The one or more edible oils and/or creams (e.g., oils having a high fatty acid content and/or creams having a high viscosity) may be present in an amount greater than 50% by volume of the formulation. The one or more oils and/or creams may be present in an amount of about 66% or greater by volume of the formulation, about 70% or greater by volume of the formulation, or about 80% by volume of the formulation. One or more oils alone may be present in an amount of about 40% or greater by volume of the formulation, about 50% or greater by volume of the formulation, or about 55% or greater by volume of the formulation. One or more oils alone may be present in an amount of about 70% or less by volume of the formulation, about 65% or less by volume of the formulation, or about 60% or less by volume of the formulation. One or more creams alone may be present in an amount of about 15% or greater by volume of the formulation, about 20% or greater by volume of the formulation, about 50% or greater by volume of the formulation, or about 80% or greater by volume of the formulation. For example, in a formulation with both an oil and a cream, the oil may be present in an amount of about 50% by volume or greater of the formulation and the cream may be present in an amount of about 20% by volume or greater. In a formulation with a cream and a yogurt (e.g., both falling under a cream as described herein), the yogurt may be present in an amount of about 50% by volume or greater of the formulation and the cream may be present in an amount of about 20% by volume or greater.

Additional oils, creams, or milks, such as those having a higher smoke point and/or lower fatty acid content, may be present in an amount of about 5% or greater by volume of the formulation, about 7% or greater by volume of the formulation, or about 10% or greater by volume of the formulation. The additional oils, creams, or milks, may be present in an amount of about 20% or less by volume of the formulation, about 17% or less by volume of the formulation, or about 15% or less by volume of the formulation.

The amount of an ingredient may depend on its form. For example, more product resulting from cooking one or more types of legumes may be required if it is in liquid form. If the product resulting from cooking one or more types of legumes is in dried or dehydrated form, less may be required. If the product resulting from cooking one or more legumes is in liquid form, it may be present in about 25% or less by volume of the formulation, about 23% or less by volume of the formulation or about 20% or less by volume of the formulation. The liquid form may be present in an amount of about 10% or greater by volume of the formulation, about 12% or greater by volume of the formulation, or about 15% or greater by volume of the formulation. If the product resulting from cooking one or more legumes is present in a dried or dehydrated form, it may be present in about 20% or less by volume of the formulation, about 17% or less by volume of the formulation, about 12% or less by volume of the formulation, or about 10% or less by volume of the formulation. The dried or dehydrated form may be present in an amount greater than 0% by volume of the formulation, about 0.05% or greater by volume of the formulation, or about 0.1% or greater by volume of the formulation. For example, the dried or dehydrated form may be present in an amount less than 1% by volume of the formulation.

Other emulsifiers, such as one or more lecithins, may be present in an amount of about 0.2% or greater by volume of the formulation, about 0.5% or greater by volume of the formulation, or about 1% or greater by volume of the formulation. The one or more lecithins may be present in an amount of about 5% or less by volume of the formulation, about 3% or less by volume of the formulation, or about 2% or less by volume of the formulation.

Ingredients for flavoring, such as one or more edible yeasts, may be provided in an amount of about 0.2% or greater by volume of the formulation, about 0.5% or greater by volume of the formulation, or about 1% or greater by volume of the formulation. The one or more edible yeasts may be present in an amount of about 5% or less by volume of the formulation, about 3% or less by volume of the formulation, or about 2% or less by volume of the formulation. Ingredients, such as salt, which may act as an emulsifier and/or a flavoring agent, may be present in an amount of about 0.1% or greater by volume of the formulation, about 0.2% or greater by volume of the formulation, or about 0.7% or greater by volume of the formulation. The salt may be present in an amount of about 5% or less by volume of the formulation, about 3% or less by volume of the formulation, or about 2% or less by volume of the formulation.

Other additives, such as preservatives or other flavor enhancers, may be provided in an amount of about 1% or less by volume of the formulation, about 0.5% or less by volume of the formulation, or about 0.1% or less by volume of the formulation. These additives may be present in minute amounts. These additives may be omitted altogether.

It is contemplated that the edible product as described herein can be used as a condiment, such as one that is spreadable. The edible product as described herein may be melted for baking or cooking or melted during the baking or cooking process. The edible product may be an ingredient within a baked good or other food. The edible product as used herein may be used for cooking (e.g., melting in a pan for providing flavor and/or non-stick properties while searing, sautéing, or the like). The edible product as described herein may be used in any application where traditional butter may be used. The edible product as described herein may be used as a topping or spread. For example, the edible product may be a whipped topping, a frosting, a dressing (e.g., salad dressing), a mayonnaise, a legume-based spread, a sauce, a cheese substitute (e.g., a non-dairy sour cream or cottage cheese), or an egg white substitute

The formulation may be prepared by blending or mixing together the ingredients described herein. The ingredients may be added together at once and mixed with a blender. The blend cycle may be about 10 seconds or greater, about 20 seconds or greater, or about 30 seconds or greater. The blend cycle may be about 5 minutes or less, about 3 minutes or less, or about 1 minute or less.

Certain ingredients may be mixed together prior to mixing with other ingredients. The process may include steps of dispersing the dry ingredients in a liquid medium before mixing, where the liquid medium may be an oil or water. Water and dry ingredients may be mixed together. Oil and oil-soluble ingredients may be mixed together. For example, water and dry ingredients may be added together and added to the oil ingredients and oil soluble ingredients. The ingredients may pass through one or more mixing tanks, one or more holding tanks, one or more heating processes, one or more cooling processes, or a combination thereof. The mixture may be passed through one or more blending processes, which may knead the mixture and/or keep the mixture soft and pliable. The mixture may undergo one or more whipping processes. If the mixture, or parts thereof, are not adequately heated or melted, the mixture or part thereof may be re-entered into the system for re-heating or re-melting (e.g., at the heating stage of the process). Processing of the edible product may be performed, at least in part, through the use of one or more scraped-surface heat exchangers. Some or all of the ingredients may be pumped into a scraped-surface heat exchanger, where it may be continuously mixed. Some or all of the ingredients may be pumped from one scraped-surface heat exchanger to another (e.g., if a different temperature is required, if ingredients are added, if a different mixing speed is required, or the like). After undergoing processing, the edible product may be packaged.

The method may include a flash heating step. The flash heating step may act to pasteurize the edible product.

### ILLUSTRATIVE EXAMPLES

Trials are conducted for various ingredients in various combinations. The various combinations are shown in the tables below. Unless otherwise noted, the formulations do not melt too soon at room temperature (e.g., do not melt completely and/or separate in about 120 minutes or less, or about 60 minutes or more). The formulations in accordance with the present teachings may soften when exposed to room temperature (e.g., in a period of about 15 minutes or more, or about 30 minutes or more, about 2 hours or less, or about 1 hour or less) similar to traditional butter. It is contemplated that the formulations in accordance with the present teachings may be left out at room temperature for about 18 hours or more, about 20 hours or more, or about 24 hours or more. The formulations may be left out at room temperature for about 60 hours or less, about 50 hours or less, or about 48 hours or less. For example, the formulations in accordance with the present teachings may be left out at room temperature for about 24 hours to about 48 hours, which is comparable to the timeframe traditional dairy butter may be left at room temperature. Unless otherwise noted, the formulations have a creamy mouthfeel, have a smooth texture, are spreadable, remain emulsified with melting and/or cooking, and do not exhibit clumping during melting and/or cooking.

TABLE 1

| Ingredient | Trial 1 | Trial 2 | Trial 3 | Trial 4 | Trial 5 | Trial 6 | Trial 7 |
|---|---|---|---|---|---|---|---|
| Extra virgin | X | X | X | X | | | |
| coconut oil | | | | | | | |
| Refined | | | | | X | X | X |
| coconut oil | | | | | | | |
| Coconut | | | | | | | |
| cream | | | | | | | |
| Cashew | | X | | | X | | |
| yogurt | | | | | | | |
| Almond | | | X | | | X | |
| yogurt | | | | | | | |
| Coconut | | | | X | | | X |
| yogurt | | | | | | | |
| Grapeseed | X | X | X | X | X | X | X |
| oil | | | | | | | |
| Safflower oil | | | | | | | |
| Sunflower | | | | | | | |
| oil | | | | | | | |
| Almond milk | | | | | | | |
| Nutritional | | | | | | | |
| yeast | | | | | | | |
| Sunflower | | | | | | | |
| lecithin | | | | | | | |
| (liquid) | | | | | | | |
| Sunflower | | | | | | | |
| lecithin | | | | | | | |
| (powdered) | | | | | | | |
| Salt | X | X | X | X | X | X | X |
| Sea salt | | | | | | | |
| Aquafaba | X | X | X | X | X | X | X |
| (liquid) | | | | | | | |
| Aquafaba | | | | | | | |
| (dehydrated) | | | | | | | |
| Lemon juice | X | X | X | X | X | X | X |
| Citric acid | | | | | | | |
| Cultured | | | | | | | |
| dextrose | | | | | | | |
| Lactic acid | | | | | | | |

The formulation of trial 1 is found to have a sour flavor. The formulations of trials 1-7 have a lemony odor. The formulations of trials 1-7 also melt too soon at room temperature. The formulations of trials 1-7 have a grainy mouthfeel and a flaky consistency. The formulations of trials 2-7 are difficult to spread.

TABLE 2

| Ingredient | Trial 8 | Trial 9 | Trial 10 | Trial 11 | Trial 12 | Trial 13 | Trial 14 | Trial 15 |
|---|---|---|---|---|---|---|---|---|
| Extra virgin | | | | | | | | |
| coconut oil | | | | | | | | |
| Refined | X | X | X | X | X | X | X | X |
| coconut oil | | | | | | | | |
| Coconut | | | | | | | | |
| cream | | | | | | | | |
| Cashew | X | | | X | | | | |
| yogurt | | | | | | | | |
| Almond | | X | | | X | | | |
| yogurt | | | | | | | | |
| Coconut | | | X | | | X | | |
| yogurt | | | | | | | | |
| Grapeseed | X | X | X | X | X | X | X | |
| oil | | | | | | | | |
| Safflower oil | | | | | | | | |
| Sunflower | | | | | | | | X |
| oil | | | | | | | | |
| Almond milk | | | | | | | X | X |
| Nutritional | | | | | | | | |
| yeast | | | | | | | | |
| Sunflower | | | | | | | | |
| lecithin | | | | | | | | |
| (liquid) | | | | | | | | |
| Sunflower | | | | X | X | X | X | X |
| lecithin | | | | | | | | |
| (powdered) | | | | | | | | |
| Salt | X | X | X | X | X | X | X | X |
| Sea salt | | | | | | | | |
| Aquafaba | X | X | X | X | X | X | X | X |
| (liquid) | | | | | | | | |
| Aquafaba | | | | | | | | |
| (dehydrated) | | | | | | | | |
| Lemon juice | | | | | | | | |
| Citric acid | | | | | | | | |
| Cultured | | | | | | | | |
| dextrose | | | | | | | | |
| Lactic acid | | | | | | | | |

The formulation of trials 8-10 melt too soon at room temperature. The formulations of trials 8-15 have a grainy mouthfeel and a flaky consistency. The formulations of trials 8-15 are also difficult to spread. The emulsion breaking with air melting or cooking is observed for the formulations of trials 8-15. Clumping during cooking and/or melting processes is also observed in trials 8-15.

TABLE 3

| Ingredient | Trial 16 | Trial 17 | Trial 18 | Trial 19 | Trial 20 | Trial 21 | Trial 22 | Trial 23 |
|---|---|---|---|---|---|---|---|---|
| Extra virgin | | | | | | | | |
| coconut oil | | | | | | | | |
| Refined | X | X | X | X | X | X | X | X |
| coconut oil | | | | | | | | |
| Coconut | X | X | X | X | X | X | X | X |
| cream | | | | | | | | |
| Cashew | | | | | | | | |
| yogurt | | | | | | | | |
| Almond | | | | | | | | |
| yogurt | | | | | | | | |
| Coconut | | | | | | | | |
| yogurt | | | | | | | | |
| Grapeseed | | | | | | | | |
| oil | | | | | | | | |
| Safflower oil | | | | | | | | |
| Sunflower | X | X | X | X | X | X | X | X |
| oil | | | | | | | | |
| Almond milk | | | | | | | | |
| Nutritional | | | | | | | | |
| yeast | | | | | | | | |
| Sunflower | | | | | | | | |
| lecithin | | | | | | | | |
| (liquid) | | | | | | | | |
| Sunflower | X | X | X | X | X | X | X | X |
| lecithin | | | | | | | | |
| (powdered) | | | | | | | | |
| Salt | X | X | X | X | X | X | X | X |
| Sea salt | | | | | | | | |
| Aquafaba | X | | | | | | | |
| (liquid) | | | | | | | | |
| Aquafaba | | X | X | X | X | X | X | X |
| (dehydrated) | | | | | | | | |
| Lemon juice | | | | | | | | |
| Citric acid | | | | | | | | |
| Cultured | | | | | | | | |
| dextrose | | | | | | | | |
| Lactic acid | | | | | | | | |

The formulations of trials 16-23 are found to have a grainy mouthfeel; however, the formulations are not observed to have a flaky consistency. The formulation of trial 16 is too easily spread, while the formulations of trials 17-23 are spreadable. In trial 16, the emulsion breaking with air melting or cooking is observed, as well as clumping during the cooking and/or melting process. In trials 17-23, clumping during the cooking and/or melting process is observed. Trial 18 has an increased amount of coconut oil from trial 17. Trial 19 has a reduced amount of coconut cream from trial 18. Trial 20 has an increased amount of sunflower oil from trial 19. Trial 21 has an increased amount of sunflower lecithin from trial 20. Trial 22 has an increased amount of salt from trial 21. Trial 23 has a reduced amount of dehydrated aquafaba from trial 22.

TABLE 4

| Ingredient | Trial 24 | Trial 25 | Trial 26 | Trial 27 | Trial 28 | Trial 29 | Trial 30 |
|---|---|---|---|---|---|---|---|
| Extra virgin | | | | | | | |
| coconut oil | | | | | | | |
| Refined | X | X | X | X | | | |
| coconut oil | | | | | | | |
| Coconut | X | X | X | X | X | X | X |
| cream | | | | | | | |
| Cashew | | | | | | | |
| yogurt | | | | | | | |
| Almond | | | | | | | |
| yogurt | | | | | | | |
| Coconut | | | | | X | X | X |
| yogurt | | | | | | | |
| Grapeseed | | | | | | | |
| oil | | | | | | | |
| Safflower oil | | | | | | | |
| Sunflower | X | X | X | X | X | X | X |
| oil | | | | | | | |
| Almond milk | | | | | | | |
| Nutritional | X | X | X | X | X | X | X |
| yeast | | | | | | | |
| Sunflower | | | | | | | |
| lecithin | | | | | | | |
| (liquid) | | | | | | | |
| Sunflower | X | X | X | X | X | X | X |
| lecithin | | | | | | | |
| (powdered) | | | | | | | |
| Salt | | | | | | | |
| Sea salt | X | X | X | X | X | X | X |
| Aquafaba | | | | | | | |
| (liquid) | | | | | | | |
| Aquafaba | X | X | X | X | X | X | X |
| (dehydrated) | | | | | | | |
| Lemon juice | | | | | | | |
| Citric acid | | | | | X | | |
| Cultured | | | X | X | | | X |
| dextrose | | | | | | | |
| Lactic acid | | X | | X | | | X |

The formulation of trial 28 has a very sweet taste. The formulation of trial 29 has a grainy mouthfeel, and clumping during the cooking and/or melting process is observed. The formulations for trials 24-28 and 30 are found to be creamy and spreadable without clumping during the cooking and/or melting process.

It is contemplated that other additives may be present within the formulations above, particularly the formulations having creamy and spreadable properties. For example, vitamins, minerals, or extracts, such as Vitamin D, food coloring (e.g. annatto), or natural flavors (e.g., those derived from spices and/or fruits, such as flaxseed, oregano, and/or plum), may be present.

While the discussion and examples herein provide examples of ingredients, it is to be understood that these ingredients are not intended as limiting. Fats and oils, which may be present in any of the oils or creams as described herein, belong to a subgroup of lipids. The present teachings contemplate the use of, but are not limited to, any combination of the following lipids: acai oil, almond butter, almond oil, almond milk, amla oil, apricot kernel butter, apricot kernel oil, argan oil, avocado butter, avocado oil, bay leaf oil, babassu oil, beech nut oil, black cumin seed oil, black currant seed oil, borage oil, brazil nut oil, buriti oil, butternut squash seed oil, camelina oil, canola oil, caprylic capric triglycerides (MCT oil), cashew nut oil, castor oil, cherry kernel oil, cocoa butter, cocoa oil, coconut oil, coconut cream oil, coffee bean butter, corn oil, cottonseed oil, cucumber seed oil, cupuacu butter, elderberry seed oil, flax seed oil, grape seed oil, hazelnut oil, hemp seed butter, hemp seed oil, hibiscus oil, illipe butter, linseed oil, macadamia nut butter, macadamia nut oil, mango butter, mango oil, manketti oil, marula oil, meadowfoam seed oil, mongongo nut oil, moringa oil, niger seed oil, nilotica butter, oat oil, olive butter, olive oil, palm oil, peach kernel oil, peanut oil, pecan oil, perilla oil, pine nut oil, pilu oil, pistachio nut butter, pistachio oil, pomegranate seed oil, poppy seed oil, pumpkin seed oil, quinoa oil, rapeseed oil, red raspberry seed oil, rice bran oil, rosehip oil, sacha inchi oil, safflower oil, sesame oil, shea butter, shea oil, soybean oil, stearic acid, strawberry seed oil, sunflower oil, sweet almond oil, tigernut oil, walnut oil, watermelon seed oil, wheat germ oil.

The edible product, such as a spreadable condiment, may be free of preservatives, such as EDTA, artificial ingredients, synthetic chemicals, artificial and/or natural flavorings, artificial and/or natural sweeteners, artificial and/or natural colorings, eggs, products derived from eggs, dairy, products containing dairy, lactose, or a combination thereof. The condiment may include eggs or egg whites (e.g., in addition to or instead of the aquafaba or product derived from cooking one or more types of legumes). The edible product may be free of gluten. The edible product may be free of genetically modified organisms. The edible product may be free of soy. The edible product may be free of allergens. The edible product may be free of allergens with the exception of coconuts, which are deemed tree nuts by the Federal Drug Administration. The edible product may be Kosher and/or pareve. The edible product may be considered clean label.

While the present teachings are discussed in terms of an edible product, it is also contemplated that the formulations described herein may be useful for other purposes. For example, the formulation may be a body butter or a topical cream for skin and/or hair.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of a range in terms of at “‘x’ parts by weight of the resulting composition” also contemplates a teaching of ranges of same recited amount of “‘x’ in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

It will be appreciated that concentrates or dilutions of the amounts recited herein may be employed. In general, the relative proportions of the ingredients recited will remain the same. Thus, by way of example, if the teachings call for 30 parts by weight of a Component A, and 10 parts by weight of a Component B, the skilled artisan will recognize that such teachings also constitute a teaching of the use of Component A and Component B in a relative ratio of 3:1. Teachings of concentrations in the examples may be varied within about 25% (or higher) of the stated values and similar results are expected. Moreover, such compositions of the examples may be employed successfully in the present methods. Alternate expressions of percent by weight (or wt %) also envision parts by weight. Expressions of parts by weight also envision percent by weight (or wt %), for example.

What is claimed is:

1. A formulation comprising:
a. two or more edible plant oils or creams; and
b. a product resulting from cooking one or more types of legumes,
wherein the formulation is a condiment spread, topping, cooking or baking ingredient, or a combination thereof.

2. The formulation of claim 1, further comprising an edible oil, cream, or milk derived from a plant and having a lower fatty acid content than another edible plant oil or cream within the formulation.

3. The formulation of claim 1 or 2, wherein the one or more legumes are characterized as having a carbohydrate to protein content in a ratio of about 2:1 to about 4:1.

4. The formulation of any of the preceding claims, wherein the one or more legumes are characterized as having a carbohydrate to lipid content in a ratio of about 9:1 to about 12:1.

5. The formulation of any of the preceding claims, wherein the one or more legumes are characterized as having a protein to lipid content in a ratio of about 2:1 to about 5:1.

6. The formulation of any of the preceding claims, wherein the product resulting from cooking one or more types of legumes acts as an emulsifying agent.

7. The formulation of any of the preceding claims, further comprising a natural flavoring.

8. The formulation of claim 7, wherein the natural flavoring includes a yeast product.

9. The formulation of claim 8, wherein the yeast product is a deactivated yeast.

10. The formulation of claim 9, wherein the deactivated yeast includes a strain of microorganism Saccharomyces cerevisiae.

11. The formulation of any of the preceding claims, wherein the one or more types of legumes are selected from black beans, pinto beans, green split peas, adzuki beans, mung beans, chickpeas, green peas, roman beans, light red beans, pink peas, kidney beans, lima beans, lentils, and navy beans.

12. The formulation of any of the preceding claims, further comprising one or more emulsifiers.

13. The formulation of claim 12, wherein the emulsifier includes lecithin from a plant source.

14. The formulation of any of the preceding claims, wherein the formulation includes one or more additives.

15. The formulation of any of the preceding claims, wherein the additives are selected from salt, citrus juice, lactic acid, cultured dextrose, vinegar, sodium benzoate, potassium sorbate, or a combination thereof.

16. The formulation of any of the preceding claims, wherein the two or more edible plant oils or creams are selected from any combination of cottonseed oil (e.g., hydrogenated), palm oil (e.g., hydrogenated), coconut oil, palm kernel oil, pilu oil, bay leaf oil, almond yogurt, coconut yogurt, cashew yogurt, and coconut cream.

17. The formulation of any of the preceding claims, wherein the condiment spread is a butter.

18. A formulation comprising:
a. an oil or cream derived from a plant having a saturated fatty acid content in excess of 70% by weight of total fat;
b. a slurry or emulsion having a relatively high viscosity;
c. an oil, cream, or milk from a plant having a saturated fatty acid content less than that of a.; and
d. a product resulting from cooking one or more types of legumes.

19. The formulation of claim 18, wherein the slurry or emulsion has a viscosity of about 1000 centipoise (cP) or greater.

20. The formulation of claim 18 or 19, wherein the slurry or emulsion has a viscosity of about 250,000 cP or less.

21. The formulation of any of claims 18 to 20, wherein the slurry or emulsion is selected from one or more of almond yogurt, coconut yogurt, cashew yogurt, and coconut cream.

22. The formulation of any of claims 18 to 21, wherein the oil, cream, or milk from a plant is selected from one or more of oils derived from seeds or nuts (which may be detoxified), safflower oil, grapeseed oil, rapeseed oil, hemp seed oil, flaxseed oil, linseed oil, canola oil, sunflower oil, avocado oil, corn oil, olive oil, peanut oil, soybean oil, palm oil, cottonseed oil, tigernut oil, almond milk, cashew milk, and coconut milk.

23. The formulation of any of claims 18 to 22, wherein the one or more legumes are characterized as having a carbohydrate to protein content in a ratio of about 2:1 to about 4:1.

24. The formulation of any of claims 18 to 23, wherein the one or more legumes are characterized as having a carbohydrate to lipid content in a ratio of about 9:1 to about 12:1.

25. The formulation of any of claims 18 to 24, wherein the one or more legumes are characterized as having a protein to lipid content in a ratio of about 2:1 to about 5:1.

26. The formulation of any of claims 18 to 25, wherein the product resulting from cooking one or more types of legumes acts as an emulsifying agent.

27. The formulation of any of claims 18 to 26, wherein the one or more types of legumes are selected from black beans, pinto beans, green split peas, adzuki beans, mung beans, chickpeas, green peas, roman beans, light red beans, pink peas, kidney beans, lima beans, lentils, and navy beans.

28. The formulation of any of claims 18 to 27, further comprising a natural flavoring.

29. The formulation of claim 28, wherein the natural flavoring includes a yeast product.

30. The formulation of claim 29, wherein the yeast product is a deactivated yeast.

31. The formulation of claim 30, wherein the deactivated yeast includes a strain of microorganism Saccharomyces cerevisiae.

32. The formulation of any of claims 18 to 31, further comprising one or more emulsifiers.

33. The formulation of claim 32, wherein the emulsifier includes lecithin from a plant source.

34. The formulation of any of claims 18 to 33, wherein the formulation includes one or more additives.

35. The formulation of any of claims 18 to 34, wherein the additives are selected from salt, citrus juice, lactic acid, cultured dextrose, vinegar, sodium benzoate, potassium sorbate, food coloring, or a combination thereof.

36. The formulation of any of claims 18 to 35, wherein the condiment spread is a butter.

37. A formulation of comprising:
a. an oil derived from a plant having a saturated fatty acid content in excess of 70% by weight of total fat, wherein the oil is present in an amount of about 50% or greater by volume of the formulation;
b. a slurry or emulsion having a relatively high viscosity, wherein the slurry or emulsion is a cream or yogurt present in an amount of about 20% or greater by volume of the formulation;
c. an oil, cream, or milk from a plant having a saturated fatty acid content less than that of a., wherein the oil, cream or milk is present in an amount of about 15% or less by volume of the formulation; and
d. a product resulting from cooking one or more types of legumes.

38. The formulation of claim 37, wherein the product resulting from cooking one or more types of legumes is in a viscous liquid form.

39. The formulation of claim 38, wherein the viscous liquid is present in an amount of about 20% or less by volume of the formulation.

40. The formulation of claim 37, wherein the product resulting from cooking one or more types of legumes is in a dried or dehydrated form.

41. The formulation of claim 40, wherein the dried or dehydrated product is present in an amount of about 10% or less by volume of the formulation.

42. The formulation of claim 41, wherein the dried or dehydrated product is present in an amount of about 1% or less by volume of the formulation.

43. The formulation of any of claims 37 to 42, further comprising a natural flavoring.

44. The formulation of claim 43, wherein the natural flavoring includes a yeast product.

45. The formulation of claim 44, wherein the yeast product is present in an amount of about 0.5% or greater by volume of the formulation and about 3% or less by volume.

46. The formulation of any of claims 37 to 45, further comprising lecithin from a plant source.

47. The formulation of claim 46, wherein the lecithin from a plant source is present in an amount of about 0.2% or greater by volume of the formulation and about 3% or less by volume of the formulation.

48. The formulation of any of claims 37 to 47, wherein the condiment spread is a butter.

49. A process for making the formulation of any of the preceding claims, comprising blending or mixing the ingredients.

50. The process of claim 49, further comprising a step of pasteurizing the formulation.
